(19) United States
(12) Patent Application Publication
(10) Pub. No.: US 2023/0176850 A1
(43) Pub. Date: Jun. 8, 2023

(54) VEHICLE UPDATE SYSTEM AND METHOD

(71) Applicants: HYUNDAI MOTOR COMPANY, Seoul (KR); Kia Corporation, Seoul (KR)

(72) Inventors: Yo An OH, Ansan-si (KR); Tae Ho Lee, Seoul (KR)

(73) Assignees: HYUNDAI MOTOR COMPANY, Seoul (KR); Kia Corporation, Seoul (KR)

(21) Appl. No.: 17/879,043

(22) Filed: Aug. 2, 2022

(30) Foreign Application Priority Data
Dec. 7, 2021 (KR) 10-2021-0174121

(51) Int. Cl. G06F 8/65; H04L 67/00; H04L 67/12

(52) U.S. Cl. CPC G06F 8/65; H04L 67/12; H04L 67/34

(57) ABSTRACT

A vehicle update system includes a server that stores a new version of vehicle software, and a vehicle update device that determines an update method of the vehicle software according to a vehicle state and a communication state with the server to improve a customer’s satisfaction by minimizing failure of update.

### CROSS-REFERENCE TO RELATED APPLICATION

The present application claims priority to Korean Patent Application No. 10-2021- 0174121, filed on Dec. 7, 2021, the entire contents of which is incorporated herein for all purposes by this reference.

### BACKGROUND OF THE PRESENT DISCLOSURE

### Field of the Present Disclosure

The present disclosure relates to a vehicle update system and method.

### Description of Related Art

A plurality of electronic devices is provided in a vehicle, and software is stored in the electronic device. Software needs to be updated periodically for correcting errors, improving performance, and adding new functions compared to previous versions, as the software affects not only the convenience functions of the vehicle but also the driving of the vehicle.

Software update methods may largely include an over-the-air (OTA) method and a USB method. The OTA method updates only the differences between the previous versions and the new version of software, and the USB method overwrites the previous version of software with the entire file of the new version of the software.

Although the OTA method has a small download capacity, the OTA method requires wireless communication connection, and has a download time which is increased according to a communication state, so that the update is generally performed after an ignition is turned on. On the other hand, although the USB method has a large download capacity, the update is performed regardless of a wireless communication state, so that the update is possible even after the ignition is turned off.

However, the software update method has a limitation in that only one method is set according to a user’s selection. Therefore, there is a demand for a technology for effectively updating software by appropriately selecting a software update method based on a vehicle state and communication state.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle update system and method configured for updating software by appropriately selecting a software update method based on a vehicle state and a communication state.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle update system includes a server that stores a new version of vehicle software, and a vehicle update device that determines an update method of the vehicle software according to a vehicle state and a communication state with the server.

The vehicle update device may include storage that stores the new version of the vehicle software.

The update method of the vehicle software may include an Over-The-Air (OTA) method of updating the vehicle software using the new version of the vehicle software downloaded from the server and a USB method of updating the vehicle software using the new version of the vehicle software received from the storage.

The vehicle update device is configured to determine the USB method as the update method when a vehicle is in an ignition-off state or when a communication speed is less than a reference speed according to the communication state with the server.

The vehicle update device is configured to compare an update time required to complete updating using the OTA method with an update time required to complete updating using the USB method when the vehicle is switched to an ignition-on state and when the communication speed is greater than or equal to the reference speed after the update method has been determined to be the USB method.

The vehicle update device is configured to switch the update method to the OTA method when the update time required to complete the updating using the OTA method is less than the update time required to complete the updating using the USB method.

The vehicle update device is configured to maintain the USB method as the update method when the update time required to complete the updating using the OTA method is not less than the update time required to complete the updating using the USB method.

The vehicle update device is configured to determine an available time of a vehicle battery and an update time required to perform update to the new version and determine the update method of the vehicle software by comparing the update time with the available time of the vehicle battery.

The vehicle update device is configured to determine the USB method as the update method when the available time of the vehicle battery is less than the update time.

The vehicle update device is configured to determine the OTA method as the update method when the available time of the vehicle battery is not less than the update time.

The vehicle update device is configured to stop update of the vehicle software in the OTA method, inform the stop of the update, and switch the update method of the vehicle software to the USB method when communication with the server is not normal while the vehicle software is being updated in the OTA method.

The vehicle update device is configured to inform a remaining time until the updating of the vehicle software is completed through the OTA method, and switch the update method of the vehicle software to the USB method when the vehicle is switched to an ignition-off state while the vehicle software is being updated in the OTA method.

The vehicle update device is configured to compare a time required to complete the updating of the vehicle software in the OTA method with a time required to complete the updating of the vehicle software in the USB method when the vehicle is switched to an ignition-on state while the vehicle software is being updated in the USB method.

The vehicle update device is configured to switch the update method to the OTA method when the time required to complete the updating of the vehicle software in the OTA method is less than the time required to complete the updating of the vehicle software in the USB method.

The vehicle update device is configured to maintain the USB method as the update method when the time required to complete the updating of the vehicle software in the OTA method is not less than the time required to complete the updating of the vehicle software in the USB method.

According to an aspect of the present disclosure, a vehicle update method includes determining a communication state with a server storing a vehicle state and a new version of vehicle software, and determining an update method of the vehicle software according to the vehicle state and the communication state with the server.

The vehicle may include storage that stores the new version of the vehicle software.

The update method of the vehicle software may include an Over-The-Air (OTA) method of updating the vehicle software using the new version of the vehicle software downloaded from the server and a USB method of updating the vehicle software using the new version of the vehicle software received from the storage.

The vehicle update method may further include determining the update method as the USB method when a vehicle is in an ignition-off state or when a communication speed is less than a reference speed according to the communication state with the server.

The vehicle update method may further include comparing an update time required to complete updating using the OTA method with an update time required to complete updating using the USB method when the vehicle is switched to an ignition-on state or when the communication speed is greater than or equal to the reference speed after the update method has been determined to be the USB method.

The vehicle update method may further include switching the update method to the OTA method when the update time required to complete the updating using the OTA method is less than the update time required to complete the updating using the USB method.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a configuration of a vehicle update system according to an exemplary embodiment of the present disclosure;

FIG. 2 is a diagram illustrating a configuration of a vehicle update device according to an exemplary embodiment of the present disclosure;

FIG. 3A, FIG. 3B, FIG. 3C, and FIG. 3D are diagrams illustrating guide messages output according to an exemplary embodiment of the present disclosure;

FIG. 4 is a diagram illustrating a configuration of a server according to an exemplary embodiment of the present disclosure;

FIG. 5 is a flowchart illustrating a vehicle update method according to an exemplary embodiment of the present disclosure;

FIG. 6, FIG. 7, FIG. 8, FIG. 9 and FIG. 10 are flowcharts illustrating a vehicle update method according to another exemplary embodiment of the present disclosure; and

FIG. 11 is a diagram illustrating a configuration of a computing system for executing a method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment according to an exemplary embodiment of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

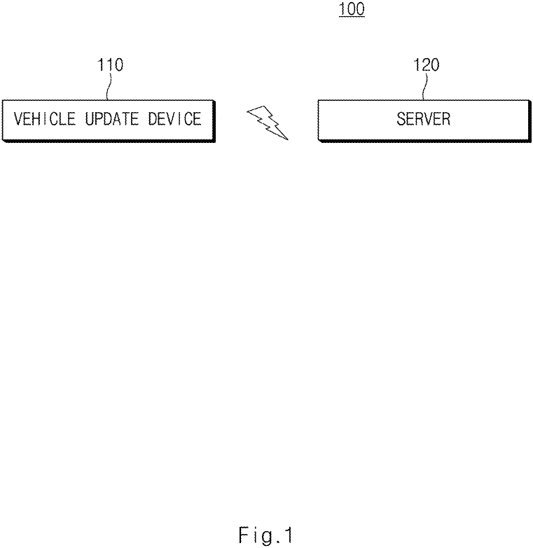

FIG. 1 is a diagram illustrating a configuration of a vehicle update system according to an exemplary embodiment of the present disclosure.

Referring to FIG. 1, a vehicle update system 100 according to an exemplary embodiment of the present disclosure may include a vehicle update device 110 and a server 120.

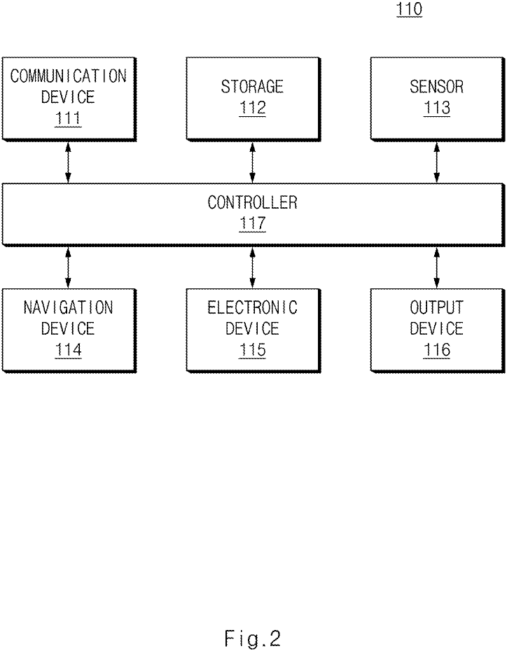

The vehicle update device 110 may determine an update method of vehicle software according to a vehicle state and a communication state with the server 120. Here, the update method is an over-the-air (OTA) method of performing update using a new version of the vehicle software downloaded from the server 120 and a USB method of performing update using a new version of the vehicle software received from storage 112 (FIG. 2). The vehicle update device 110 may determine the update method as the USB method when an update size is greater than a reference capacity or the remaining amount of a vehicle battery is less than a reference value, and determine the update method as the OTA method when an update size is less than a reference capacity or the remaining amount of a vehicle battery is greater than a reference value. In more detail, the vehicle update device 110 will be described with reference to FIG. 2.

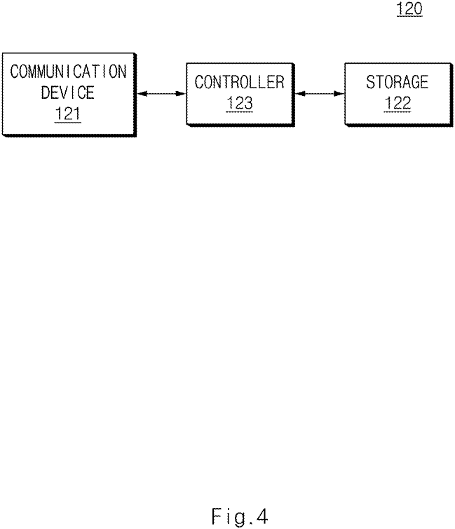

The server 120 may wirelessly communicate with the vehicle update device, and a new version of the vehicle software may be stored. In more detail, the operation of the server 120 will be described with reference to FIG. 4.

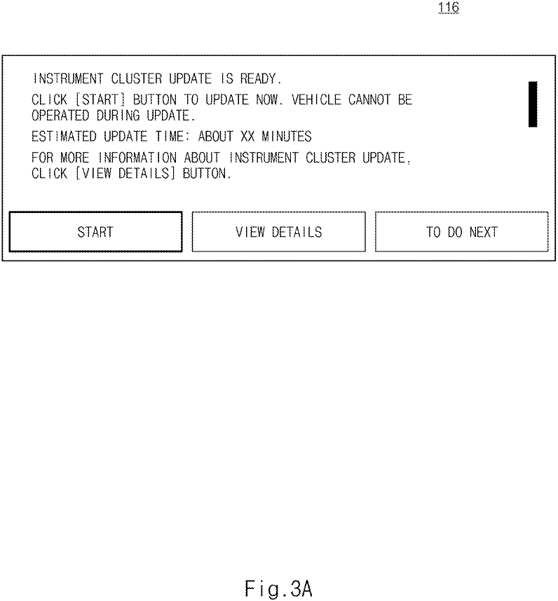

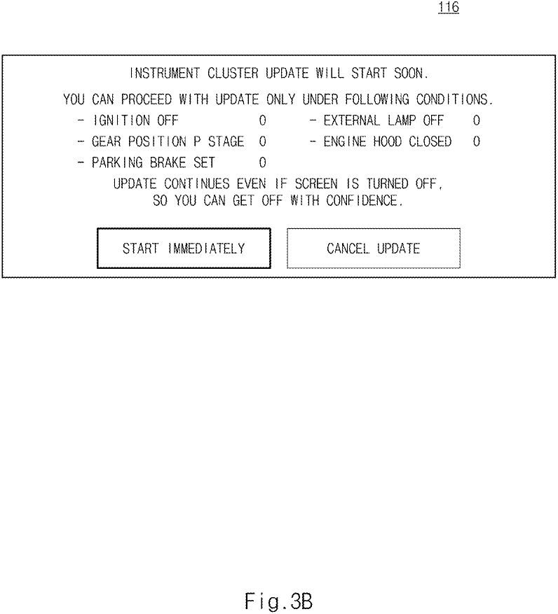

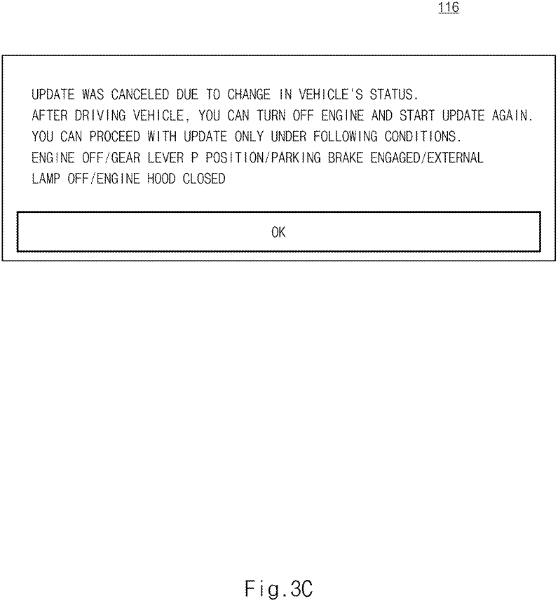

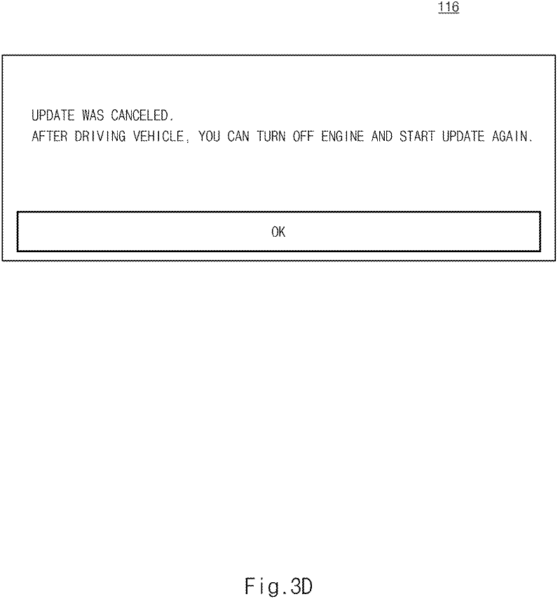

FIG. 2 is a diagram illustrating a configuration of a vehicle update device according to an exemplary embodiment of the present disclosure, and FIG. 3A, FIG. 3B, FIG. 3C, and FIG. 3D are diagrams illustrating guide messages output according to an exemplary embodiment of the present disclosure.

Referring to FIG. 2, the vehicle update device 110 may include a communication device 111, the storage 112, a sensor 113, a navigation device 114, an electronic device 115, an output device 116, and a controller 117.

The communication device 111 may wirelessly communicate with the server 120 to download a new version of the vehicle software stored in the server 120. The communication device 111 may communicate with the server 120 in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), and Long Term Evolution (LTE).

In addition, the communication device 111 may communicate with the storage 112 to download a new version of the vehicle software stored in the storage 112. The communication device 111 may be connected to the storage 112 through USB.

The storage 112 may store a new version of the vehicle software. According to an exemplary embodiment of the present disclosure, the storage 112 may include an external hard disk type storage device provided with a USB communication port. Furthermore, the storage 112 may store at least one or more algorithms for performing operations or execution of various commands for the operation of the vehicle update device according to an exemplary embodiment of the present disclosure. The storage 112 may include at least one medium of a flash memory, a hard disk, a memory card, a Read-Only Memory (ROM), a Random Access Memory (RAM), an Electrically Erasable Programmable Read-Only Memory (EEPROM), a Programmable Read-Only Memory (PROM), a magnetic memory, a magnetic disk, and an optical disk.

The sensor 113 may obtain a vehicle state and a communication state. The sensor 113 may obtain battery state information including a battery temperature, a battery current, a battery voltage, and the like of the vehicle, and a vehicle state including ignition state information of the vehicle.

The navigation device 114 may include a Global Positioning System (GPS) receiver to receive a current location of the vehicle, and may provide speed information, destination information, and the like.

The electronic device 115 may include an AVN device including an audio device, a video device, and the navigation device 114, a body control device configured for automatically adjusting a seat, a mirror, or the like of the vehicle, a chassis control device configured for controlling a steering device, a suspension device, or a braking device, an engine control device configured for controlling an engine and a transmission of the vehicle, and the like. The electronic device 115 may include software for operation, and the software may be required to be periodically updated for improvement in performance.

The output device 116 may output a message to be provided to a driver in a form of voice or image, and may be implemented with, for example, a display device or a sound output device. Here, the display device may include a display of the navigation device 114, a HUD, a cluster, and the like.

The controller 117 may be implemented by various processing devices such as a microprocessor incorporating a semiconductor chip configured for operating or executing various instructions or the like and may control an operation of the vehicle update device according to an exemplary embodiment of the present disclosure.

When the vehicle is in an ignition-on state, the controller 117 may determine whether there is an updated version of the electronic device in the server 120 or the storage 112. When it is determined that there is an updated version of the electronic device, the controller 117 may output an update notification. Here, the controller 117 may output the update notification through voice or image.

After the update notification is output, the controller 117 may determine whether the vehicle is switched to an ignition-off state or a communication speed is less than a reference speed due to a communication problem with the server 120.

When it is determined that the vehicle is switched to an ignition-off state or a communication speed is less than a reference speed due to a communication problem with the server 120, the controller 117 may determine the update method as the USB method.

After the update method is determined as the USB method, the controller 117 may determine whether it is necessary to output a notification to the driver. When it is determined that it is necessary to output a notification, the controller 117 may output a message to the driver.

According to the exemplary embodiment of the present disclosure, when the controller 117 determines that the vehicle is in the ignition-off state, the controller 117 may determine that it is necessary to confirm to the driver whether to perform update in the OTA method when the vehicle is switched to the ignition-on state, determine it is necessary to output a notification and output a message “Do you want to continue update in the OTA method when the vehicle is subsequently switched to the ignition-on state?”.

When it is determined that the driver has made a selection to continuously perform update in the OTA method when the vehicle is subsequently switched to the ignition-on state after the message is output, the controller 117 may perform the update in the OTA method when the vehicle is subsequently switched to the ignition-on state.

Furthermore, according to another exemplary embodiment of the present disclosure, when it is determined that the communication speed is less than the reference speed, the controller 117 determines that the update is about to be completed within a predetermined time period. In the instant case, when the controller 117 determines that it is necessary to confirm to the driver whether to maintain the ignition-on state and complete the update, the controller 117 may output a notification to the driver. Accordingly, the controller 117 may output a message “X minutes remain in the update. Do you want to maintain the ignition-on state?”.

When it is determined that the driver has made a selection to maintain the ignition-on state, the controller 117 may maintain the ignition-on state and perform the update in an OTA method.

On the other hand, when a time required to complete the update is greater than a set time, the controller 117 may determine that it is unnecessary to make a confirmation to the driver and continue to perform the update in the USB method.

Thereafter, the controller 117 may determine whether the vehicle is switched to the ignition-on state and the communication speed is greater than or equal to a reference speed. When it is determined that the vehicle is switched to the ignition-on state and the communication speed is equal to or greater than the reference speed, the controller 117 may compare an update time required to perform update using the OTA method and an update time required to perform update using the USB method.

According to an exemplary embodiment of the present disclosure, when the update time required to perform update using the OTA method is less than the update time required to perform update using the USB method, the controller 117 may switch an update method to the OTA method. Meanwhile, when the update time required to perform update using the OTA method is not less than the update time required to perform update using the USB method, the controller 117 may maintain the update method as the USB method.

When the vehicle is in an ignition-on state, the controller 117 may determine whether an updated version of the electronic device exists in the server 120 or the storage 112. When it is determined that there is an updated version of the electronic device, the controller 117 may determine an update time based on the size of an update file and the communication speed with the server 120. Here, the update time may mean a time required to complete the update.

When the update time is determined, the controller 117 may determine the update method by comparing the update time with an available time of a vehicle battery.

According to an exemplary embodiment of the present disclosure, when the available time of the vehicle battery is less than the update time, the controller 117 may determine that the vehicle battery is unable to be used until the update is completed, and thus determine the update method as the USB method in the ignition-off state. Furthermore, when the available time of the vehicle battery is not less than the update time, the controller 117 may determine that the vehicle battery is able to be used until the update is completed, and thus determine the update method as the OTA method in the ignition-on state.

The controller 117 may determine whether communication with the server 120 is hard while performing the update in the OTA method in the ignition-on state. According to an exemplary embodiment of the present disclosure, the controller 117 may determine that communication with the server 120 is hard when the vehicle enters an underground parking lot or a tunnel.

When it is determined that communication with the server 120 is hard, the controller 117 may output a voice or an image to inform the driver that the update of the OTA method is to be stopped, and switch the update method to the USB method.

When it is determined that the vehicle is switched to the ignition-off state during the OTA update in the ignition-on state, the controller 117 may stop the OTA update and inform the driver of a remaining time for the OTA update to be completed. Furthermore, the controller 117 may switch the update method to the USB method, and inform the driver that the update is completed.

When the controller 117 determines that the vehicle is switched to the ignition-on state during the update in the USB method in the ignition-off state, the controller 117 may compare a time required to complete the update of the vehicle software in the OTA method with a time required to complete the update of the vehicle software in the USB method.

The controller 117 may switch the update method to the OTA method when the time required to complete the update of the vehicle software in the OTA method is less than the time required to complete the update of the vehicle software in the USB method. Meanwhile, the controller 117 may maintain the USB method as the update method when the time required to complete the update of the vehicle software in the OTA method is not less than the time required to complete the update of the vehicle software in the USB method.

When the update method is determined to be the USB method, the controller 117 may output a guide message informing that the update is performed in the USB method through the output device 116. According to an exemplary embodiment of the present disclosure, a guide message as shown in FIG. 3A and FIG. 3B may be output.

The controller 117 may determine whether a condition for performing update in the USB method is satisfied. According to an exemplary embodiment of the present disclosure, the controller 117 may determine that the condition for performing update in the USB method is not satisfied when an ignition or external lamp is not in the OFF state, a gear position is not in the P position, an engine hood is not in a closed state, or a parking brake is not engaged.

Furthermore, the controller 117 may determine that the condition for performing update in the USB method is not satisfied when an existing update version is restored, when the backup of a system partition fails, when the update is successful, when the update is forcibly canceled, when the ignition prohibition is not possible, when the cumulative number of cancellations of the update is greater than or equal to a predetermined number of times, when the vehicle is switched to a state in which update is not possible, or when the decryption of software in the navigation device 114 fails.

When it is determined that the condition for performing update using the USB method is satisfied, the controller 117 may perform the USB update. However, when it is determined that the condition for performing update in the USB method is not satisfied, the controller 117 may output a message indicating that the update condition is not satisfied and the update is to be canceled. According to an exemplary embodiment of the present disclosure, when the condition for performing update in the USB method is not satisfied, the controller 117 may output a message as shown in FIGS. 3C and 3D.

When the update condition of the USB method is not satisfied, the controller 117 may determine whether software to be updated is mandatory software. Here, the mandatory software may include software required for an update system or software required for vehicle driving.

When it is determined that the software to be updated is not the mandatory software, the controller 117 may end the update. Meanwhile, when it is determined that the software to be updated is the mandatory software, the controller 117 may determine the update time based on the size of an update file and the communication speed with the server 120. Here, the update time may mean a time required to complete the update. That is, according to the exemplary embodiment of the present disclosure, even though the update condition of the USB method is not satisfied, the controller 117 may allow the update to be completed without being terminated when the software to be updated is the mandatory software.

When the update time is determined, the controller 117 may determine the update method by comparing the update time with a vehicle battery available time.

According to an exemplary embodiment of the present disclosure, when the available time of the vehicle battery is less than the update time, the controller 117 may determine that the vehicle battery is unable to be used until the update is completed, and thus determine the update method as the USB method. Furthermore, when the available time of the vehicle battery is not less than the update time, the controller 117 may determine that the vehicle battery is able to be used until the update is completed, and thus determine the update method as the OTA method.

FIG. 4 is a diagram showing a configuration of a server according to an exemplary embodiment of the present disclosure;

Referring to FIG. 4, the server 120 may include a communication device 121, storage 122, and a controller 123.

The communication device 121 may wirelessly communicate with the vehicle update device 110. According to an exemplary embodiment of the present disclosure, the communication device 121 may communicate with the vehicle update device 110 in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), and Long Term Evolution (LTE).

The storage 122 may store a new version of the vehicle software. The storage 122 may include at least one medium of a flash memory, a hard disk, a memory card, a Read-Only Memory (ROM), a Random Access Memory (RAM), an Electrically Erasable Programmable Read-Only Memory (EEPROM), a Programmable Read-Only Memory (PROM), a magnetic memory, a magnetic disk, and an optical disk.

The controller 123 may be implemented by various processing devices such as a microprocessor incorporating a semiconductor chip configured for operating or executing various instructions or the like and may control an operation of the server according to an exemplary embodiment of the present disclosure. According to an exemplary embodiment of the present disclosure, the controller 123 may perform control to transmit a new version of the vehicle software to the vehicle update device 110.

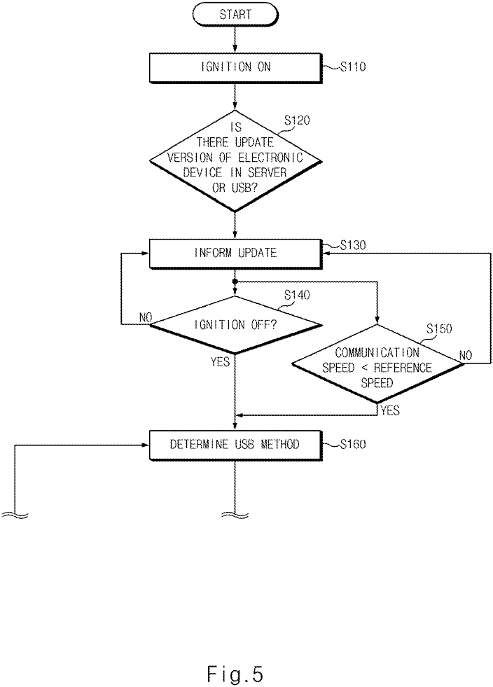

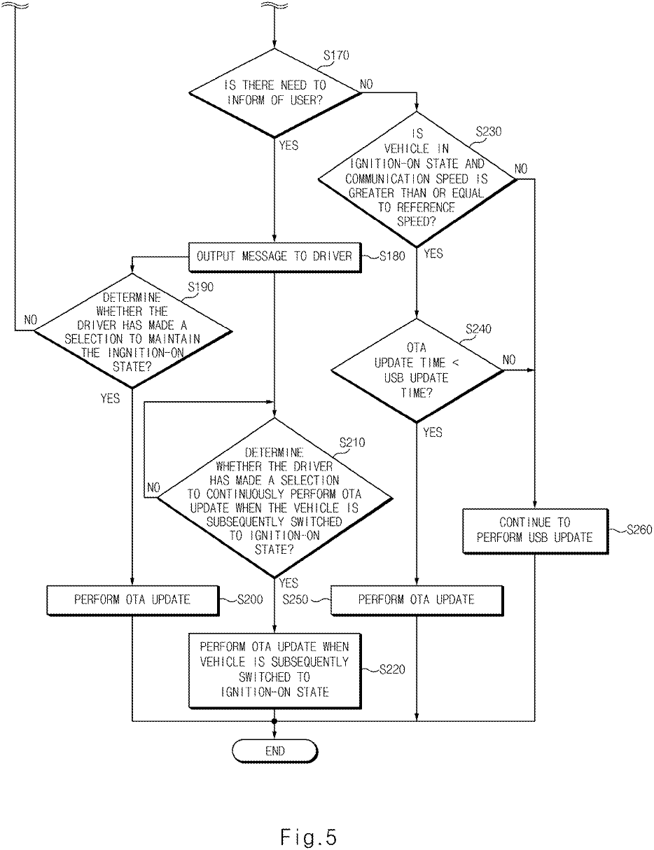

FIG. 5 is a flowchart illustrating a vehicle update method according to an exemplary embodiment of the present disclosure;

Referring to FIG. 5, when the vehicle is in an ignition-on state (S110), the controller 117 may determine whether an updated version of the electronic device exists in the server 120 or the storage 112 (S120).

When it is determined that there is an updated version of the electronic device in S120, the controller 117 may output an update notification (S130). In S130, the controller 117 may output the update notification through voice or image.

After the update notification is output, the controller 117 may determine whether the vehicle is switched to an ignition-off state (S140) or a communication speed is less than a reference speed due to a communication problem with the server 120 (S150).

When it is determined that the vehicle is switched to an ignition-off state (Y in S140) or a communication speed is less than a reference speed due to a communication problem with the server 120 (Y in S150), the controller 117 may determine the update method as the USB method (S160). When the vehicle is not switched to the ignition-off state (N in S140) or it is determined that the communication speed is not less than the reference speed (N in S150), S130 may be performed.

After the update method is determined as the USB method, the controller 117 may determine whether it is necessary to output a notification to the driver (S170). When it is determined that it is necessary to output a notification(Y in S170), the controller 117 may output a message to the driver (S180).

According to the exemplary embodiment of the present disclosure, when the controller 117 determines that the vehicle is in the ignition-off state in S140, the controller 117 may determine that it is necessary to confirm to the driver whether to perform update in the OTA method after the vehicle is switched to the ignition-on state, determine that it is necessary to output a notification and output a message “Do you want to continue update in the OTA method when the vehicle is subsequently switched to the ignition-on state?” in S180.

The controller 117 may determine whether the driver has made a selection to continuously perform update in the OTA method when the vehicle is subsequently switched to the ignition-on state after the message is output (S210). When it is determined that the driver has made a selection to continuously perform update in the OTA method when the vehicle is subsequently switched to the ignition-on state (Y in S210), the controller 117 may perform the update in the OTA method when the vehicle is subsequently switched to the ignition-on state (S220).

Furthermore, according to another exemplary embodiment of the present disclosure, when it is determined that the communication speed is less than the reference speed, but the controller 117 determines that the update is about to be completed within a predetermined time in S150, the controller 117 may determine that it is necessary to confirm to the driver whether to maintain the ignition-on state and complete the update and output a notification to the driver, and output a message “X minutes remain in the update. Do you want to maintain the ignition-on state?” in S180.

The controller 117 may determine whether the driver has made a selection to maintain the ignition-on state (S190). When it is determined that the driver selects to maintain the ignition-on state, the controller 117 may maintain the ignition-on state and perform the update in an OTA method (S200).

Meanwhile, when a time required to complete the update is greater than a set time in S170, the controller 117 may determine that it is unnecessary to form a confirmation to the driver (N) and continue to perform the update in the USB method.

Thereafter, the controller 117 may determine whether the vehicle is switched to the ignition-on state and the communication speed is greater than or equal to a reference speed (S230).

When it is determined that the vehicle is switched to the ignition-on state and the communication speed is equal to or greater than the reference speed (Y in S230), the controller 117 may determine whether an update time required to perform update using the OTA method is less than an update time required to perform update using the USB method (S240). On the other hand, when it is determined that the vehicle is not switched to the ignition-on state and the communication speed is not higher than or equal to the reference speed (N in S230), the update method may be maintained as the USB method (S260).

According to an exemplary embodiment of the present disclosure, when the update time required to perform update using the OTA method is less than the update time required to perform update using the USB method (Y in S240), the controller 117 may switch an update method to the OTA method (S250). Meanwhile, when the update time required to perform update using the OTA method is not less than the update time required to perform update using the USB method (N in S240), the controller 117 may maintain the update method as the USB method (S260).

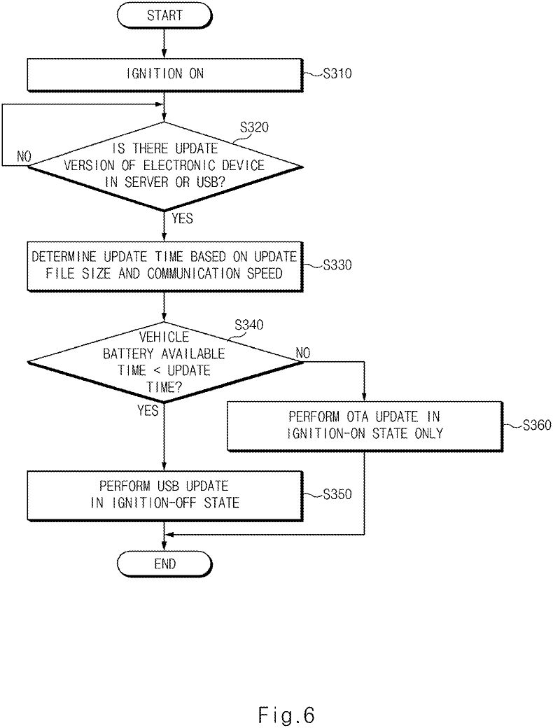

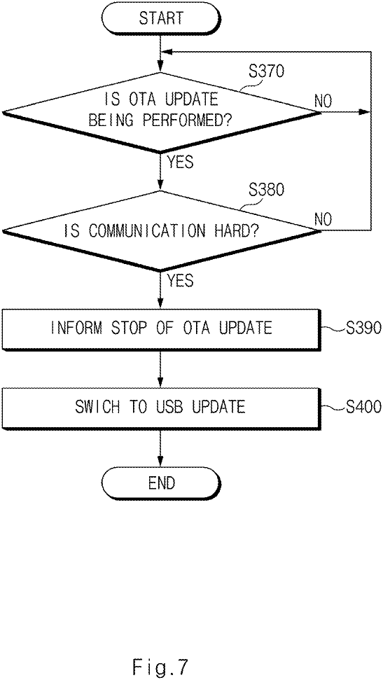

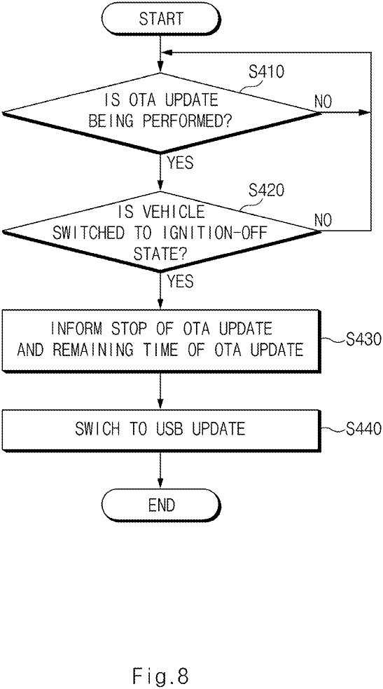

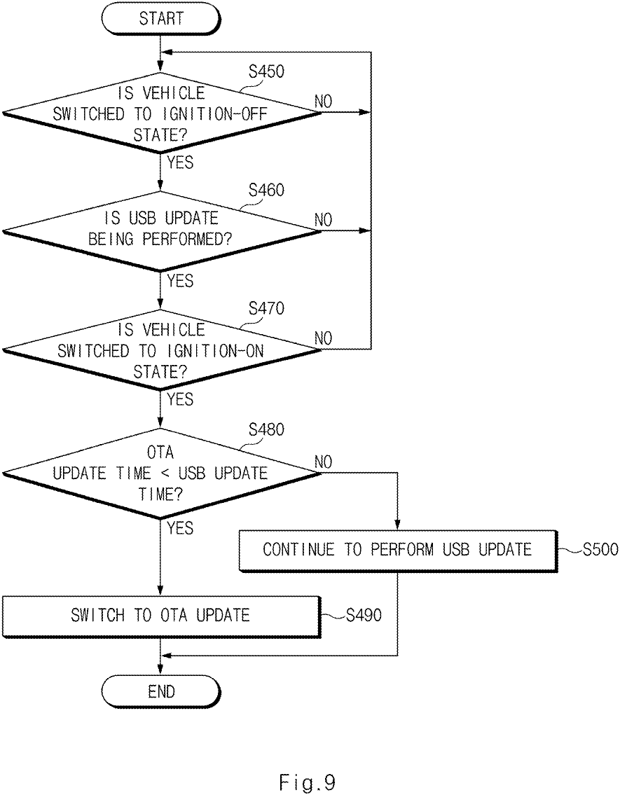

FIG. 6, FIG. 7, FIG. 8, FIG. 9 and FIG. 10 are flowcharts illustrating a vehicle update method according to another exemplary embodiment of the present disclosure; and

Referring to FIG. 6, when the vehicle is in an ignition-on state (S310), the controller 117 may determine whether an updated version of the electronic device exists in the server 120 or the storage 112 (S320).

When it is determined that there is an updated version of the electronic device (Y in S320), the controller 117 may determine an update time based on the size of an update file and the communication speed with the server 120 (S330). In S330, the update time may mean a time required to complete the update.

When the update time is determined, the controller 117 may determine whether the available time of a vehicle battery is less than the update time (S340).

According to an exemplary embodiment of the present disclosure, when the available time of the vehicle battery is less than the update time (Y in S340), the controller 117 may determine that the vehicle battery is unable to be used until the update is completed, and thus determine the update method as the USB method in the ignition-off state (S350). Furthermore, when the available time of the vehicle battery is not less than the update time (N in S340), the controller 117 may determine that the vehicle battery is able to be used until the update is completed, and thus determine the update method as the OTA method in the ignition-on state (S360).

Referring to FIG. 7, the controller 117 may determine whether the vehicle software is being updated in the OTA method (S370). According to an exemplary embodiment of the present disclosure, it is understood that S370 is performed after operation S360 of FIG. 5.

The controller 117 may determine whether communication with the server 120 is hard while performing the update in the OTA method in the ignition-on state (S380). According to an exemplary embodiment of the present disclosure, the controller 117 may determine that communication with the server 120 is hard when the vehicle enters an underground parking lot or a tunnel in S380.

When it is determined that communication with the server 120 is hard (Y in S380), the controller 117 may output a voice or an image to inform the driver that the update of the OTA method is to be stopped(S390), and switch the update method to the USB method (S400).

Referring to FIG. 8, the controller 117 may determine whether the vehicle software is being updated in the OTA method (S410). According to an exemplary embodiment of the present disclosure, it is understood that S410 is to be performed after S360 of FIG. 5.

The controller 117 may determine whether the vehicle is switched to the ignition-off state during the update in the OTA method in the ignition-on state (S420). When it is determined that the vehicle is switched to the ignition-off state (Y in S420), the controller 117 may stop the OTA update and inform the driver of a remaining time for the OTA update to be completed (S430).

Furthermore, the controller 117 may switch the update method to the USB method, and inform the driver that the update is completed (S440).

Referring to FIG. 9, the controller 117 may determine whether the vehicle is in an ignition-off state (S450). S450 may be understood to be performed after operation S420 of FIG. 7.

When it is determined that the vehicle is in the ignition-off state (Y in S450), the controller 117 may determine whether the vehicle software is being updated in the USB method in the ignition-off state (S460). When it is determined in S460 that the vehicle software is being updated in the USB method (Y), the controller 117 may determine whether the vehicle is switched to the ignition-on state (S470).

When the controller 117 determines that the vehicle is switched to the ignition-on state (Y in S470), the controller 117 may determine whether a time required to complete the update of the vehicle software in the OTA method is less than a time required to complete the update of the vehicle software in the USB method (S480).

When it is determined that the time required to complete the update of the vehicle software in the OTA method is less than the time required to complete the update of the vehicle software in the USB method (Y in S480), the controller 117 may switch the update method to the OTA method (S490).

Meanwhile, when the time required to complete the update of the vehicle software in the OTA method is not less than the time required to complete the update of the vehicle software in the USB method (N in S480), the controller 117 may maintain the USB method as the update method (S500).

Referring to FIG. 10, when the update method is determined to be the USB method, the controller 117 may output a guide message informing that the update is performed in the USB method through the output device 116 (S510). According to an exemplary embodiment of the present disclosure, in S510, the controller 117 may output a guide message as shown in FIG. 3A and FIG. 3B.

The controller 117 may determine whether a condition for performing update in the USB method is satisfied (S520). According to an exemplary embodiment of the present disclosure, when an ignition or external lamp is not in the OFF state, a gear position is not in the P position, an engine hood is not in a closed state, or a parking brake is not engaged in S520, the controller 117 may determine that the condition for performing update in the USB method is not satisfied.

Furthermore, when an existing update version is restored, when the backup of a system partition fails, when the update is successful, when the update is forcibly canceled, when the ignition prohibition is not possible, when the cumulative number of cancellations of the update is greater than or equal to a predetermined number of times, when the vehicle is switched to a state in which update is not possible, or when the decryption of software in the navigation device 114 fails in S520, the controller 117 may determine that the condition for performing update in the USB method is not satisfied.

When it is determined that the condition for performing update using the USB method is satisfied in S520, the controller 117 may perform the USB update (S570). However, when it is determined that the condition for performing update in the USB method is not satisfied (N), the controller 117 may output a message indicating that the update condition is not satisfied and the update is to be canceled (S530). According to an exemplary embodiment of the present disclosure, the controller 117 may output a message as shown in FIGS. 3C and 3D in S530.

When the update condition of the USB method is not satisfied, the controller 117 may determine whether the software to be updated is mandatory software (S530). Here, the mandatory software may include software required for an update system or software required for vehicle driving.

When it is determined that the software to be updated is the mandatory software (Y in S540), the controller 117 may determine the update time based on the size of an update file and the communication speed with the server 120(S550). Here, the update time may mean a time required to complete the update. That is, according to the exemplary embodiment of the present disclosure, even though the update condition of the USB method is not satisfied, the controller 117 may allow the update to be completed without being terminated when the software to be updated is the mandatory software.

When it is determined that the software to be updated is not the mandatory software (N in S540), the controller 117 may end the update.

When the update time is determined, the controller 117 may determine whether the available time of a vehicle battery is less than the update time (S560).

According to the exemplary embodiment of the present disclosure, when the available time of the vehicle battery is less than the update time (Y in S560), the controller 117 may determine that the vehicle battery is unable to be used until the update is completed, and thus determine the USB method as the update method (S570).

Furthermore, when the available time of the vehicle battery is not less than the update time (N in S560), the controller 117 may determine that the vehicle battery is able to be used until the update is completed, and thus determine the OTA method as the update method (S580).

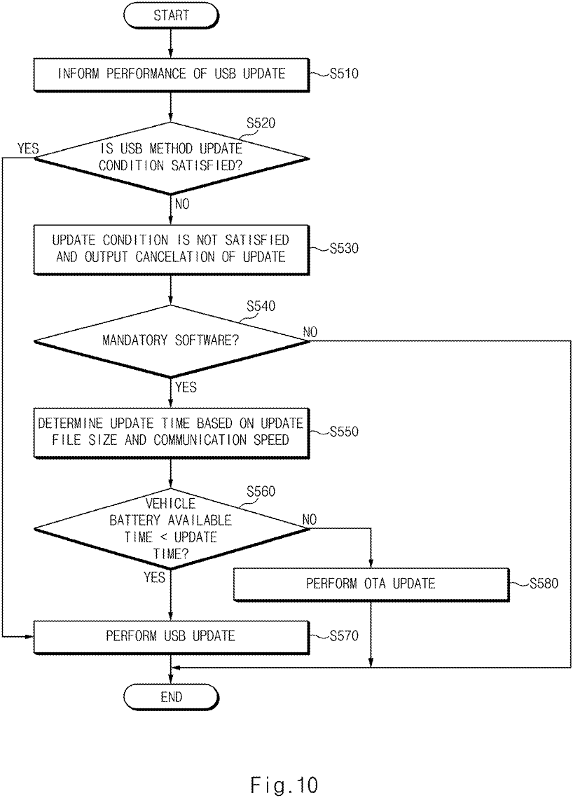

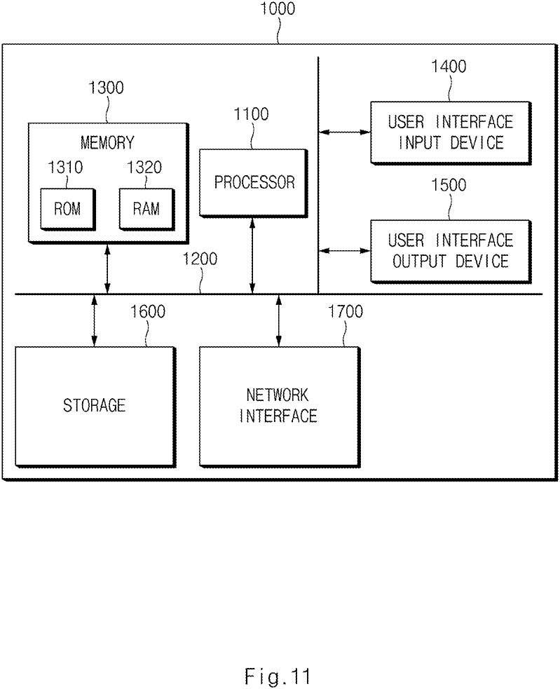

FIG. 11 is a diagram illustrating a configuration of a computing system for executing a method according to an exemplary embodiment of the present disclosure.

Referring to FIG. 11, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

According to the vehicle update system and method according to the exemplary embodiment of the present disclosure, it is possible to minimize update failure by appropriately selecting a software update method based on a vehicle state and a communication state and performing update, thus improving customer satisfaction.

In various exemplary embodiments of the present disclosure, the control device may be implemented in a form of hardware or software, or may be implemented in a combination of hardware and software.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle update system comprising:
a server configured to store a new version of vehicle software; and
a vehicle update device configured to determine an update method of the vehicle software according to a vehicle state and a communication state with the server.

2. The vehicle update system of claim 1, wherein the vehicle update device includes a storage configured to store the new version of the vehicle software therein.

3. The vehicle update system of claim 2, wherein the update method of the vehicle software includes:
an Over-The-Air (OTA) method of updating the vehicle software using the new version of the vehicle software downloaded from the server; and
a USB method of updating the vehicle software using the new version of the vehicle software received from the storage.

4. The vehicle update system of claim 3, wherein the vehicle update device is configured to determine the USB method as the update method when a vehicle is in an ignition-off state or when a communication speed is less than a reference speed according to the communication state with the server.

5. The vehicle update system of claim 4, wherein the vehicle update device is configured to compare an update time required to complete updating using the OTA method with an update time required to complete updating using the USB method when the vehicle is switched to an ignition-on state from the ignition-off state and when the communication speed is greater than or equal to the reference speed after the update method has been determined to be the USB method.

6. The vehicle update system of claim 5, wherein the vehicle update device is configured to switch the update method to the OTA method when the update time required to complete the updating using the OTA method is less than the update time required to complete the updating using the USB method.

7. The vehicle update system of claim 5, wherein the vehicle update device is configured to maintain the USB method as the update method when the update time required to complete the updating using the OTA method is not less than the update time required to complete the updating using the USB method.

8. The vehicle update system of claim 3, wherein the vehicle update device is configured to determine an available time of a vehicle battery and an update time required to perform updating to the new version and to determine the update method of the vehicle software by comparing the update time with the available time of the vehicle battery.

9. The vehicle update system of claim 8, wherein the vehicle update device is configured to determine the USB method as the update method when the available time of the vehicle battery is less than the update time.

10. The vehicle update system of claim 8, wherein the vehicle update device is configured to determine the OTA method as the update method when the available time of the vehicle battery is not less than the update time.

11. The vehicle update system of claim 9, wherein the vehicle update device is configured to stop the updating of the vehicle software in the OTA method, to inform the stop of the updating, and to switch the update method of the vehicle software to the USB method when communication with the server is not normal while the vehicle software is being updated in the OTA method.

12. The vehicle update system of claim 11, wherein the vehicle update device is configured to inform a remaining time until the updating of the vehicle software is completed through the OTA method, and configured to switch the update method of the vehicle software to the USB method when the vehicle is switched to an ignition-off state while the vehicle software is being updated in the OTA method.

13. The vehicle update system of claim 12, wherein the vehicle update device is configured to compare a time required to complete the updating of the vehicle software in the OTA method with a time required to complete the updating of the vehicle software in the USB method when the vehicle is switched to an ignition-on state from the ignition-off state while the vehicle software is being updated in the USB method.

14. The vehicle update system of claim 13, wherein the vehicle update device is configured to switch the update method to the OTA method when the time required to complete the updating of the vehicle software in the OTA method is less than the time required to complete the updating of the vehicle software in the USB method.

15. The vehicle update system of claim 13, wherein the vehicle update device is configured to maintain the USB method as the update method when the time required to complete the updating of the vehicle software in the OTA method is not less than the time required to complete the updating of the vehicle software in the USB method.

16. A vehicle update method comprising:
determining, by a controller, a communication state with a server storing a vehicle state and a new version of a vehicle software; and
determining, by the controller, an update method of the vehicle software according to the vehicle state and the communication state with the server.

17. The vehicle update method of claim 16, wherein the vehicle includes a storage configured to store the new version of the vehicle software therein.

18. The vehicle update method of claim 17, wherein the update method of the vehicle software includes:
an Over-The-Air (OTA) method of updating the vehicle software using the new version of the vehicle software downloaded from the server; and
a USB method of updating the vehicle software using the new version of the vehicle software received from the storage.

19. The vehicle update method of claim 18, further including:
determining, by the controller, the update method as the USB method when a vehicle is in an ignition-off state or when a communication speed is less than a reference speed according to the communication state with the server.

20. The vehicle update method of claim 19, further including:
comparing, by the controller, an update time required to complete updating using the OTA method with an update time required to complete updating using the USB method when the vehicle is switched to an ignition-on state from the ignition-off state or when the communication speed is greater than or equal to the reference speed after the update method has been determined to be the USB method.

21. The vehicle update method of claim 20, further including:
switching, by the controller, the update method to the OTA method when the update time required to complete the updating using the OTA method is less than the update time required to complete the updating using the USB method.
